(19) United States
(12) Patent Application Publication
(10) Pub. No.: US 2016/0157461 A1
(43) Pub. Date: Jun. 9, 2016

(54) Animal Alimentation Device

(71) Applicant: Peter Anthony Hill, Redditch (GB)

(72) Inventor: Peter Anthony Hill, Redditch (GB)

(21) Appl. No.: 14/562,722

(22) Filed: Dec. 7, 2014

(51) Int. Cl. A01K 5/01

(52) U.S. Cl. CPC A01K 5/0142; A01K 5/0114

(57) ABSTRACT

According to the present invention there is provided an animal alimentation device comprising a body, an alimentation area, a lid for said area, a lock for said lid, and a actuation means for the lock; characterised in that said key and the lock are equipped with complimentary characteristics, wherein said characteristics are such that approximation of the key to the lock allows it to as an actuator of the actuation means, and the lid is arranged to be elevated by a separate mechanism.

### FIELD OF THE INVENTION

The present invention relates to an animal alimentation device, more particularly but not exclusively an animal alimentation device wherein access to said device is triggered by the animal.

### BACKGROUND

When feeding animals it is important to feed fresh food, however often animals will pick at their food feeding at different intervals during the day therefore it may be harder to keep their food fresh without keeping the food sealed in a container.

Often owners have more than one animal and the animals may share or eat each others food. This can be problematic if they have different dietary requirements, for example if one animal requires more or less food than another, or if specialist food is required.

Therefore owners will provided separate feeding bowls for each animal and may need to monitor feeding to ensure the correct animal has the correct feed.

Alternatively the animals may require separation for feeding to ensure they only have access to the correct food. However if, as is often the case, the animals feed at intervals through the day this may not be practical or possible.

Furthermore with multiple animals it may not be possible to separate them and more aggressive animals may cause issues with others' feeding. It may therefore be difficult to monitor or control diet and for some animals this can be problematic, for example for an obese animal with associated health problems.

### PRIOR ART

Accordingly a number of patent applications have been filed in an attempt to resolve the problem or similar, including the following:

International patent application WO 2011 076 379 (STARK et al) relates to an animal food cover actuation device comprising a drive which can be controlled by a control device for actuating at least one cover which is coupled, at least indirectly, to said drive and which is used to open and/or close at least one opening releasing the animal food and/or liquids, in addition to an animal food device. The invention is characterised in that said device comprises a housing which is pivotably mounted about an axis or a spindle and to which the covering can be fixed, and the drive is mounted at least indirectly in the housing on the axis or spindle and is fixed by a device for holding the drive in its spatial position within the housing.

Granted United states patent U.S. Pat. No. 7,124,707 (CLARKE) discloses a selective animal feeding apparatus for feeding a food of a first animal to a first animal and for restricting access to said food to a second animal, comprising: (a) a container adapted to house said food of said first animal, said container including means for preventing access to said food when said apparatus is in a quiescent state said means for preventing access including a signal receiver;(b) means for accessing said food attached to said first animal wherein said means for accessing includes a transmitter, wherein when said first animal and said means for accessing is disposed proximate said container, said quiescent state is changed by said means for accessing sufficient to allow access to said food in said container by said first animal, and when said first animal and said means for accessing is disposed sufficiently far from said container, said means for accessing is of no effect and said quiescent state is returned and access to said food in said container is denied; and including means for preventing injury to said first animal or said second animal whenever access to said food in said container is denied wherein said means for preventing injury includes a lid adapted to be urged into a first, open position to allow access to said food and into a second, closed position to deny access to said food, and an actuator adapted to be urged intermediate said first position and said second position, and a spring intermediate said actuator and said lid, and wherein said spring is attached directly to said lid and wherein said spring is adapted to prevent said injury from occurring.

Granted United Kingdom patent GB 2 390 966 (NEOPHITOU) discloses an animal feeder comprises a removable bowl 4 encased in an outer shell. The shell is made up of a bottom 2 and a lid 6. The bottom section is fitted with a ramp 1. In use, the ramp is pressed down by an approaching pet causing the shell to rock forward toward the pet and the lid to rock back to uncover the bowl. When the pet steps off the ramp the shell rocks back causing the lid to close. The lid is fixed to the shell at the pivot point 9 by a flexible tape material glued to each surface. The ramp is similarly attached to the shell at point 7. The device may be made to a size suitable for horses. The feeder may be made from metal, plastic, wood or cardboard. It could be mass produced from cardboard making it suitable for disposable use.

### SUMMARY OF THE INVENTION

According to the present invention there is provided an animal alimentation device comprising a body, an alimentation area, a lid for said area, a lock for said lid, and a actuation means for the lock; characterised in that said key and the lock are equipped with complimentary characteristics, wherein said characteristics are such that approximation of the key to the lock allows it to as an actuator of the actuation means, and the lid is arranged to be elevated by a separate mechanism.

In preferred embodiments said characteristics comprise passive or inherent characteristics wherein neither the key nor the lock require extra electrical or kinetic energy in order to equip the key to actuate or activate the lock, and wherein degree of mutual approximation between key and lock is all that is necessary and wherein the key and lock mutually comprise a locking and unlocking actuation means for the area.

In particular in preferred embodiments the characteristics comprise areas with ferromagnetic properties wherein approximation of the ferromagnetic key compliments the ferromagnetic lock and activates release of the lock and consequently the lid.

In preferred embodiments the mechanism comprises sprung bias on the lid, wherein after activation of the lock the lid opens to allow access to the area.

In some embodiments the lid may be provided with an active closing or timing mechanism such as to allow the lid to fall back and close the area after a period of time, wherein after such period the spring-biasing is removed or overcome when the lid falls back to close the lock.

In preferred embodiments however the device includes an active opening mechanism, wherein said mechanism allows timing of the opening in relation to action, for example wherein action from an animal such as approximation of the animal to the area, causes the lid to remain open, and wherein movement of the animal from the area allows the lid to close the area.

In preferred embodiments therefore there is provided a pedal opening mechanism wherein the animal in approximation to the area depresses said pedal and consequently opens the lid to allow access to the area.

In other embodiments for example said opening mechanism may comprise an extendable member, sprung lid opener and weighted lid, wherein said lid is displaced and maintained open by the member, and wherein said member is arranged to extend upon depression on a platform, so as to permit weighting of the lid to close the lid. Advantageously lid closure may be dampened.

The lock actuation means therefore comprises a second stage to provide an alimentation area access apparatus and said apparatus requires both approximation of a correct animal and desire to access the area.

Typically the invention provides a lockable animal feeding device comprising: a container with a lid that together provide a closeable alimentation area, wherein the lid is displaceable at least in part from the area, so as allow an animal access to contents of the area by means of a bipartite apparatus activated by an animal presence and wish to feed or drink, wherein:

said animal carries a ferromagnetic material or magnet that unlocks the lid from the container when the animal and thereby the magnet is within a predetermined range from the device; and the lid displaces as the animal steps on a pressure sensitive pedal.

In this way contents of the area such as food and liquids are sealed until the presence of the animal requiring food or drink, and desire of the animal to access the food or drink, wherein the apparatus is activated.

In preferred embodiments the device is formed from lightweight, durable material such as synthetic plastic. Ideally the device is dimensioned to provide a bowled area or bowl in which contents are located. Preferably the area has no corners for example being concave so as to avoid a build up of food that may become stuck in corners and distasteful after a period time. Advantageously the area can therefore be more readily cleaned and in some embodiments the bowl may be removed from the area so as to enable cleaning or filling.

Preferably the lid is formed from the same material as the area and is dimensioned to enclose the area wherein contents are sealed within the area and lid. In some embodiments the area or lid may include an O-ring so as to provide a seal between the lid and area.

Preferably the lid is hingeably attached over the area so that it may be opened and closed by the opening mechanism actuated by the pedal. Typically the pedal is linked to the hinge so that as the pedal is depressed in response to weight of the animal upon the pedal the lid is opened. It may be envisaged that the pedal operates in similar manner to that of a pedal bin wherein depression of the pedal causes movement about a hinge to lift the lid and provides sufficient weight to ensure no secondary power source.

Ideally the pedal is planar, being of a suitable size to enable an animal to stand upon it with one or more of its feet or to sit upon the pedal. However due to the multi-stepped apparatus the lid cannot be displaced until it has been unlocked by presence of the key.

In preferred embodiments therefore the lid is locked closed over the area until the presence of the key wherein the lid is unlocked. Typically the lock comprises for example a hook, clip or latch wherein presence of the key causes the hook, clip or latch to displace so that the lid is no longer locked to the area.

In preferred embodiments where the key comprises a ferromagnetic key, such magnetic force pulls or causes the hook, clip or latch. Said latch may be situated on a rocker which is displaced towards the key and animal, and in consequence a pivoted movement of a distal end of a rocker releases the lid.

For example the lock may include an arm that extends to a recess on the area holding the lid to the area and wherein the arm may be linked to a magnetic plate located on the device and proximate the area. The presence of the key subsequently causes said plate to move towards the animal which in turn causes the arm to retract and thereby the lid to be released from the area. As the animal moves away from the device the magnetism between the magnet and magnetic plate is lost so the arm returns to the first position wherein the lid is locked to the area, thereby sealing the contents. It may be envisaged that this may not occur until the animal leaves the pedal and allows the lid to close therefore preventing the lid from closing on the animal's head.

In some embodiments the animal may wear a collar comprising ferromagnetic material which reacts against ferromagnetic contained on the lid, for example so as to release a catch contained therein. In this way the animal is required to approximate the lid closely and the lid is liable to be situated remote from the catch to permit free movement of the lid. Some embodiments may comprise a dual stage process wherein the animal is expected to move from one location to another to accomplish the apparatus.

In use the device is opened and closed by multiple steps:
The animal approaches the device, the key is detected and the lid is unlocked from the area;
the animal stands on/or is already standing on the pedal which is depressed by the weight of the animal thereby engages the hinge so as to open the lid;
as the animal leaves the device the pedal rises in absence of the animal's weight so that the lid is allowed to close upon the area; and
as the lid is closed it automatically becomes locked over the area due to absence of the key.

Advantageously the device can prevent animals without a key from being fed, for example if other animals steps onto the pedal, but is not carrying the or a key, the lid will not be unlocked and therefore cannot be displaced even though the pedal is depressed.

In this way the device can prevent over-feeding of animals by only allowing access to certain animals, for example an obese animal may be dispossessed of a key and therefore not be able to access the device.

In some embodiments dual location apparatus may encourage exercise and casual access or feeding. In such circumstances for example the mechanism may be arranged with a timer or limiter which permits access only after a number of actuations at the means. In other circumstance the timer may in addition or the alternative ensure that the area is closed after a period of time. This timer may combine with or replace with an actuation means for prolonged actuation.

In such embodiments for example said actuation means may be dispersed about the device so that actuation continues when the animal is a plurality of positions.

Advantageously access to the contents is restricted to all without a key therefore for example young children who may be curious as to the contents of the device are restricted from accessing the contents, as are other animals such as birds or insects that may try to feed on the contents if accessible.

The key may be carried by the animal by means of a collar, halter, harness, clothing or rug worn by the animal. In this way the key causes minimal interference to the animal and the magnet may be removed if access to the contents of the area is to be restricted.

Advantageously as the contents are enclosed within the device when not in use so the contents are kept fresh and enabled to be preserved for longer. Furthermore the device can be placed down for an animal and left unattended in the knowledge that the contents are sealed until the desired animal comes to feed from the device when it will open. in this way the contents cannot be reached by flies, vermin or other pests which might spoil the food. Also the ability for airborne bacteria to reach the contents is reduced.

Additionally contents are sealed when not in use therefore odours from the contents are contained and do linger in a household that may be unpleasant to some users or third parties.

In some embodiments the area and lid may include insulating means, for example being formed of multiple layers or including insulating materials so as to protect contents. For example the contents may be protected from fluctuations in temperature such as nearby heat from a radiator or if the device is located in direct sunlight or within a kennel positioned in sunlight.

In other embodiments the device may include compartments for receiving ice packs so as to aid with cooling the contents of the device. Preferably the compartments may be arranged on the container, for example on a side or base. Ideally the ice packs are removable so that after use they may be refrozen and the replaced into the device. Therefore contents such as food remains chilled or cooled even in warm conditions.

Advantageously the use and format of the opening mechanism and actuation means removes requirement for a power source therefore the device is not reliant on power or affected by power failure. Furthermore the device is rendered suitable for use in any location and can be readily used outdoors without risk as there are no electronic parts that may be susceptible to weather related damage.

In this way the device can continually be used by animals without requirement for user supervision and the requirement to check the power supply is alleviated. Furthermore the simple mechanism requires minimal maintenance and manufacture costs are low due use of simple mechanical parts and no electrical hardware.

Furthermore typically the device is compact so as to be discreet in any location and be suitable for transport or storage, for example if travelling by vehicle with animals or if on holiday.

It may be envisaged that embodiments of the device are arranged, suitable and dimensioned for use with various types of animals for example, dogs, cats, horses and livestock.

Typically the device may be available in various sizes so as to accommodate the feeding requirements of different animals.

### BRIEF DESCRIPTION OF FIGURES

FIG. 1 shows a side view of an embodiment of the device in use;

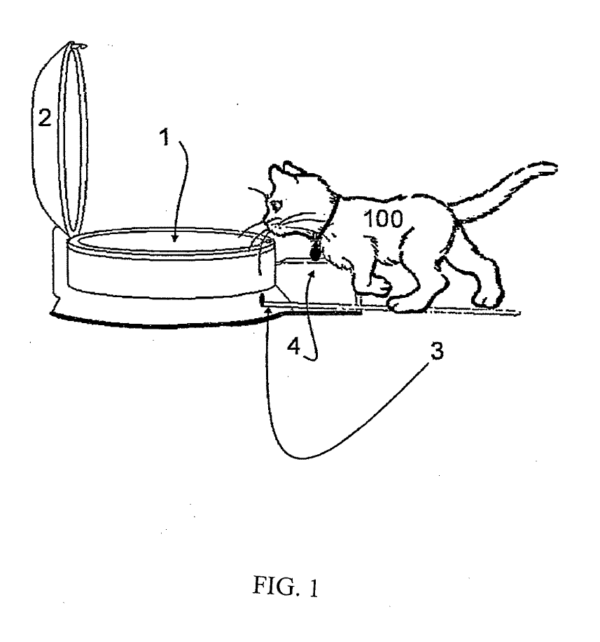

FIG. 2 shows a side view of the embodiment shown in FIG. 1;

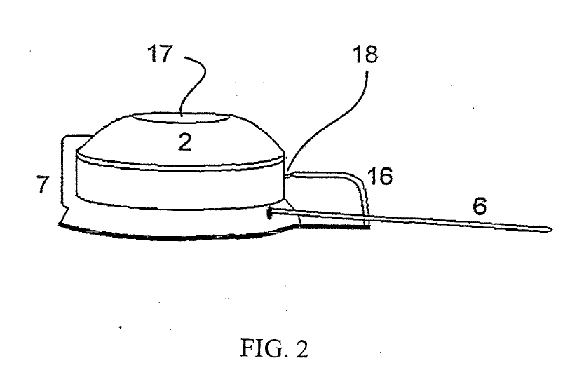

FIG. 3 shows a view from above of the embodiment shown in FIG. 1;

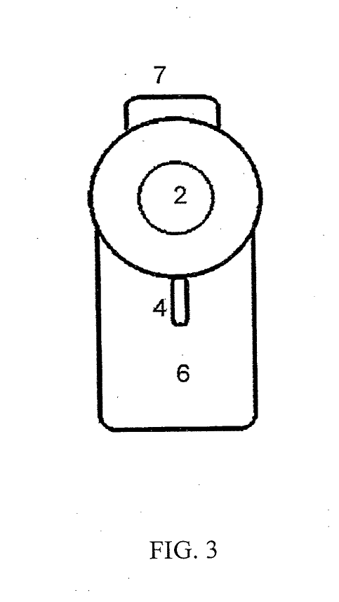

FIGS. 4 show detail view of an embodiment of an actuation means; And

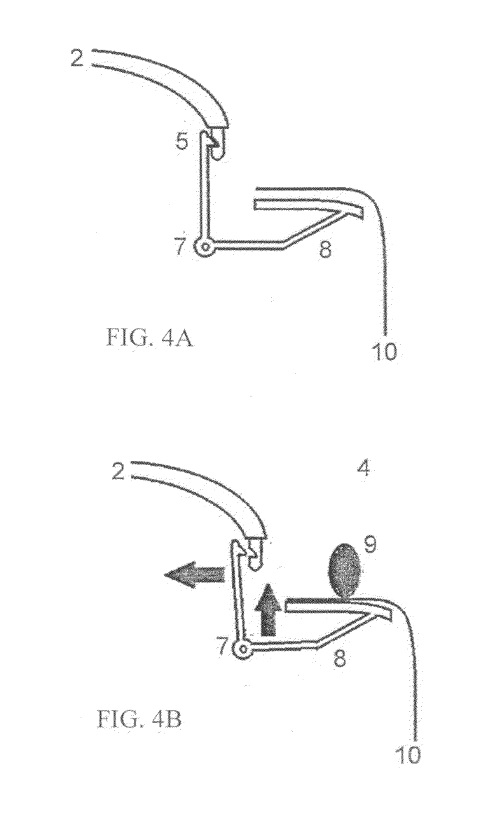

FIGS. 5 show detail views of an indicative embodiment of an opening mechanism.

### DETAILED DESCRIPTION OF FIGURES

With reference to the figures the access area 1 is covered in use by the lid 2, said lid 3 opened by an actuation means 4 and opening mechanism 3. The animal 100 opens the area 1 by approximation to the actuation means 4 and standing on the opening mechanism 3. The lid 2 includes a transparent lid section 17 and a recess 18 for placement of a sample of food during training, in order to encourage the animal 100 towards actuation and opening of the device. The device has a rubberised and/or textured base to help prevent sliding in use, and insulation means.

The actuation means 4 comprises a member 16 that is displaceable at an end to displace a catch

The actuation means 4 comprises a ferromagnetic part 9 carried on the animal 100, and arranged in use to displace a plate 8, said plate pivoting on a rocker 7 so as to free the lid 2 for movement, and to bring the plate 8, part 9 and device side 10 into proximity.

The opening mechanism 3 comprises a pedal 6 to activate a lifting element with a rear section 7 of the device.

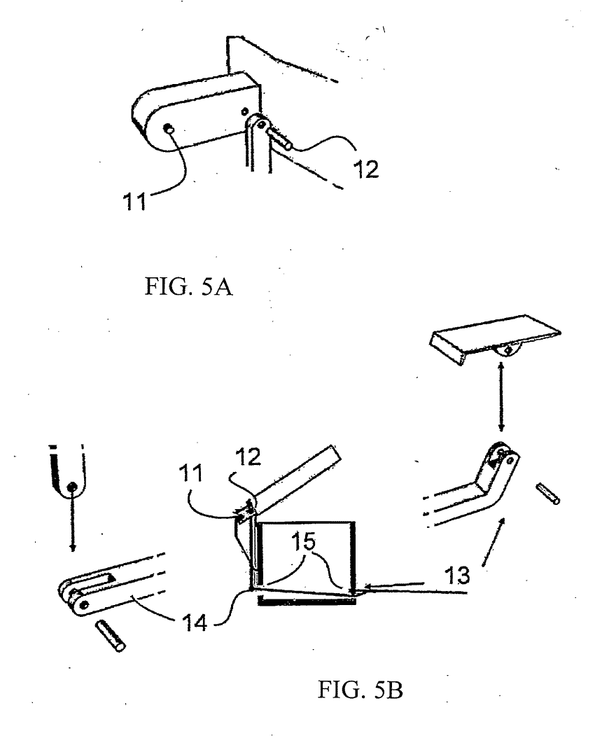

The opening mechanism internally may comprise a mechanism such as shown in FIG. 5, namely moving pivots 12,14, fixed pivot 11 and pedal moving pivot 13 and slots 15 in outer skin.

In use:
When the lid closes it self-locks by a bolt secured within a rebate in the lid.
The bolt is connected to a free moving spindle.
The weight of a ferrous metal plate keeps the bolt in the locked position.
A magnet is placed near the metal plate to unlock the lid (e.g. a magnet hanging from a cat's collar).
The plate lifts causing the spindle to turn in an anti-clockwise motion.
The bolt slides out of the rebate and the lid is unlocked.

The invention has been described by way of examples only and it will be appreciated that variation may be made to the above-mentioned embodiments without departing from the scope of invention.

With respect to the above description then, it is to be realised that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1-4. (canceled)

5. An animal alimentation device comprising a body; an alimentation area; a lid for the alimentation area; a lock for the lid; a key for the lock, the key and the lock being constructed such that the lock is unlocked by the key when the key is proximate the lock; and a lid elevating mechanism for elevating the lid when the lock is unlocked.

6. The device of claim 5, wherein the key includes a magnet.

7. The device of claim 5, wherein the lid elevating mechanism causes the lid to close when the key is no longer proximate the lock.

8. The device of claim 5, wherein the lid elevating mechanism includes a pedal opening mechanism for elevating the lid.

9. The device of claim 8, wherein the lid is hingedly attached over the area.

10. The device of claim 5 and including an O-ring so as to provide a seal between the lid and the alimentation area.

11. The device of claim 5, wherein the lock includes an arm linked to a magnetic plate located on the device proximate the alimentation area.

12. The device of claim 11, wherein the presence of the key causes the plate to move towards an animal wishing to use the device and causes the arm to retract from a first position so as to release the lid from the alimentation area.

13. The device of claim 12, wherein subsequent movement of the key away from the lock causes the arm to return to the first position such that the lid is locked to the alimentation area.

14. The device of claim 13, wherein movement of the arm to its first position occurs only when the lid elevating mechanism is not operated.

15. The device of claim 5, wherein the lock comprises a plate configured to be displaced by the key when the key is proximate the lock, the plate pivoting on a rocker so as to free the lid for movement.

16. An animal alimentation device comprising a body; an alimentation area; a lid for the alimentation area; a lock for the lid; a magnetic key for the lock, the key and the lock being constructed such that the lock is unlocked by the key when the key is proximate the lock; and a lid elevating mechanism for elevating the lid when the lock is unlocked.

17. The device of claim 16, wherein the lid elevating mechanism includes a pedal opening mechanism for elevating the lid by the weight of an animal standing on the pedal.

18. The device of claim 17, wherein the lock includes an arm linked to a magnetic plate located on the device proximate the alimentation area.

19. The device of claim 18, wherein the presence of the magnetic key causes the magnetic plate to move towards an animal wishing to use the device and causes the arm to retract from a first position so as to release the lid from the alimentation area.

20. The device of claim 19, wherein subsequent movement of the magnetic key away from the lock causes the arm to return to the first position such that the lid is locked to the alimentation area.

21. The device of claim 20, wherein movement of the arm to its first position occurs only when the lid elevating mechanism is not operated.

22. An animal alimentation device comprising a body; an alimentation area; a lid for the alimentation area; a lock for the lid; a magnetic key for the lock, the key and the lock being constructed such that the lock is unlocked by the key when the key is proximate the lock; and a lid elevating mechanism for elevating the lid when the lock is unlocked, the lid elevating mechanism including a pedal opening mechanism for elevating the lid by the weight of an animal standing on the pedal.

23. The device of claim 22, wherein the lock includes an arm linked to a magnetic plate located on the device proximate the alimentation area.

24. The device of claim 23, wherein the presence of the magnetic key causes the magnetic plate to move towards an animal wishing to use the device and causes the arm to retract from a first position so as to release the lid from the alimentation area.
